(19) United States
(12) Patent Application Publication
(10) Pub. No.: US 2017/0235861 A1
(43) Pub. Date: Aug. 17, 2017

(54) METHOD OF CALCULATING THERMAL PATH AND INFORMATION PROCESSING DEVICE

(71) Applicant: FUJITSU LIMITED, Kawasaki-shi (JP)

(72) Inventor: Hideharu Matsushita, Yokohama (JP)

(73) Assignee: FUJITSU LIMITED, Kawasaki-shi (JP)

(21) Appl. No.: 15/401,506

(22) Filed: Jan. 9, 2017

(30) Foreign Application Priority Data
Feb. 12, 2016 (JP) 2016-025369

(51) Int. Cl. G06F 17/50

(52) U.S. Cl. CPC G06F 17/5009

(57) ABSTRACT

An information processing device includes a processor configured to extract contact surfaces from among surfaces of a first component. The respective contact surfaces are in contact with a second component. The processor is configured to calculate a ratio between an area of a first contact surface and an area of a portion of the first contact surface. The portion is in contact with the second component. The processor is configured to determine whether the calculated ratio is a predetermined reference value or more, and generate first information upon determining that the calculated ratio is the predetermined reference value or more. The first information indicates a thermal path including a partial route between the first and second components. The processor is configured to generate second information upon determining that the calculated ratio is less than the predetermined reference value. The second information indicates a thermal path not including the partial route.

### CROSS-REFERENCE TO RELATED APPLICATION

This application is based upon and claims the benefit of priority of the prior Japanese Patent Application No. 2016-025369, filed on Feb. 12, 2016, the entire contents of which are incorporated herein by reference.

### FIELD

The embodiment discussed herein is related to method of calculating a thermal path and an information processing device.

### BACKGROUND

In recent years, in an electronic device in which high integration, high functionality, and miniaturization have been advancing, a margin of thermal design is being reduced. According to the three principles of heat transfer, as ways of transfer of heat, there are “conduction”, “convection”, and “radiation”. In the thermal design of the electronic device, a maximum heat dissipation route corresponds to conduction in the solid. The conduction is a phenomenon in which heat moves from a high temperature portion to a low temperature portion in objects due to the direct contact.

For example, for the thermal design, a designer visually finds a thermal path from a design target displayed based on three-dimensional design information on a computer. The thermal path is a sequence of components through which heat moves.

As a related art, for example, there is a technology by which, when a model used for thermo-fluid analysis of a product is generated, a contact portion between configuration members of the product is detected, a contact thermal resistance model is generated in the detected contact portion, at least one of the contact thermal resistance or the heat conductivity in the contact thermal resistance model is calculated, and the calculation result is stored. In addition, for example, there is a technology by which a heat movement amount between components is calculated from an analysis result obtained by performing numerical analysis on an object including a plurality of components, and the calculated heat movement amount is displayed. Further, for example, there is a technology by which a heat transfer route of a component to be evaluated is identified on the basis of thermal analysis data including a heat flow between components including the component to be evaluated and the component temperatures, and a diagram representing the identified heat transfer route is generated.

Related techniques are disclosed in, for example, Japanese Laid-open Patent Publication No. 2007-122506, Japanese Laid-open Patent Publication No. 2006-350504, and Japanese Laid-open Patent Publication No. 2014-203195.

In the method in which the designer finds a thermal path by sequentially performing a visual trace of components in contact with a component as a heating element, there is a problem that man-hour of the designer increases.

### SUMMARY

According to an aspect of the present invention, provided is an information processing device including a memory and a processor coupled to the memory. The processor is configured to extract contact surfaces from among surfaces of a first component of a plurality of components in a simulation space. The respective contact surfaces are in contact with a second component of the plurality of components. The second component is different from the first component. The processor is configured to calculate a ratio between an area of a first contact surface of the contact surfaces and an area of a portion of the first contact surface. The portion is in contact with the second component. The processor is configured to determine whether the calculated ratio is a predetermined reference value or more. The processor is configured to generate first information upon determining that the calculated ratio is the predetermined reference value or more. The first information indicates a thermal path including a partial route between the first and second components. The processor is configured to generate second information upon determining that the calculated ratio is less than the predetermined reference value. The second information indicates a thermal path not including the partial route between the first and second components.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating examples of an operation of an information processing device according to an embodiment;

FIG. 2 is a diagram illustrating an example of a thermal path;

FIG. 3 is a diagram illustrating an example of a contact, which is not related to a thermal path, at an initial design stage;

FIG. 4 is a diagram illustrating an example of a contact, which is not related to a thermal path, at a detailed design stage;

FIG. 5 is a diagram illustrating an exemplary hardware configuration of the information processing device;

FIG. 6 is a diagram illustrating an exemplary functional configuration of the information processing device;

FIG. 7 is a diagram illustrating an example in which interference occurs between components;

FIG. 8 is a diagram illustrating examples of interference surfaces;

FIG. 9 is a diagram illustrating examples of reference value information;

FIG. 10 is a diagram illustrating exemplary designs and a corresponding area ratio for each surface;

FIG. 11 is a diagram illustrating examples of calculation and determination of an area ratio;

FIG. 12 is a diagram illustrating an example of visualization target component information;

FIG. 13 is a diagram illustrating examples of connection component information;

FIG. 14 is a diagram illustrating examples of display of thermal paths;

FIG. 15 is a diagram illustrating an example of a screen operation;

FIG. 16 is a flowchart illustrating an example of a procedure of calculating a thermal path;

FIG. 17 is a flowchart illustrating an example of a procedure of calculating a thermal path;

FIG. 18 is a flowchart illustrating an example of a procedure of extracting connection components; and

FIG. 19 is a flowchart illustrating an example of a procedure of visualization.

### DESCRIPTION OF EMBODIMENT

A method of calculating a thermal path and an information processing device according to an embodiment are described in detail with reference to accompanying drawings.

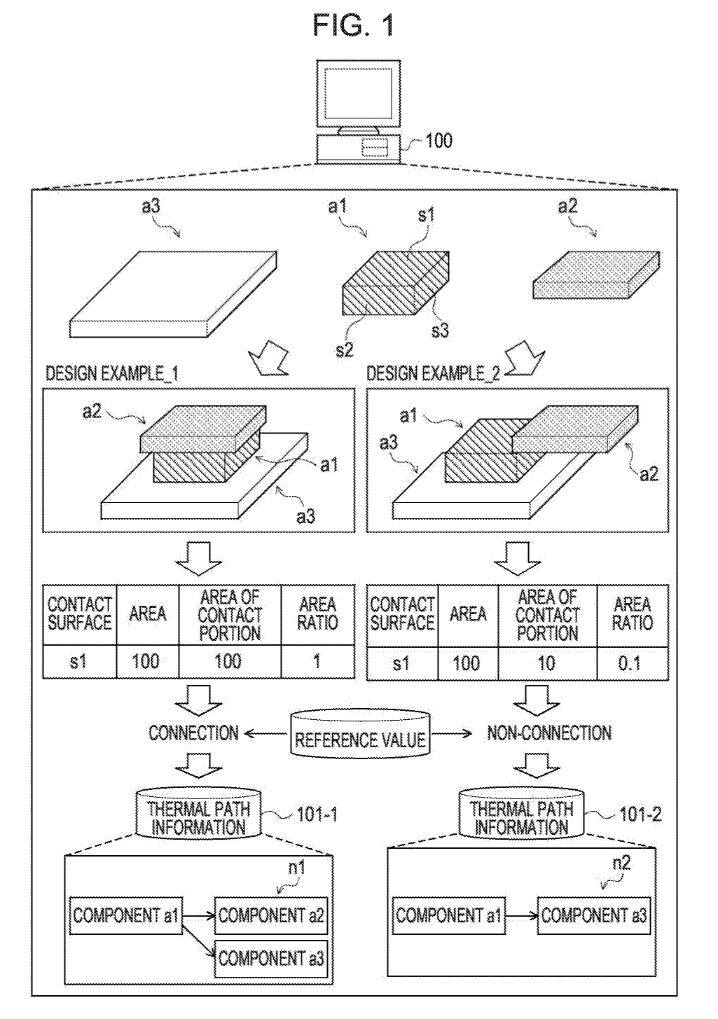

FIG. 1 is a diagram illustrating examples of an operation of an information processing device according to an embodiment. An information processing device 100 is a computer that generates a thermal path from a plurality of components as design targets in a simulation space. The information processing device 100 executes a thermal path calculation program.

In design development of a device or the like, the development in a three-dimensional space is performed using a computer aided design (CAD).

The plurality of components as the design targets are provided in the simulation space. The simulation space is a virtual three-dimensional space which is simulated on the computer. Specifically, for example, the simulation space is a space virtually set in the information processing device 100 in order to perform design and analysis on a three-dimensional object. In the simulation space, for example, a three-dimensional Cartesian coordinate system having an X axis, a Y axis, and a Z axis is defined. Examples of the object including the plurality of components are electronic devices such as a smartphone, a personal computer (PC), or a camera, but not particularly limited thereto.

For example, using the CAD, the developer creates design information of a solid model having a three-dimensional shape, which is obtained by representing the object as a polygon. The design information includes, for example, coordinate data of the polygon and the like.

In addition, as described above, recently, in an electronic device in which high integration, high functionality, and miniaturization have been advancing, a margin of thermal design is being reduced. For example, for the thermal design, the designer visually finds a thermal path from the design target displayed based on the three-dimensional design information on the computer. More specifically, the designer visually finds a thermal path by sequentially tracing components in contact with a component as a heating element. Therefore, there is a problem in which the man-hour of the designer increases. When the man-hour of the designer increases, a problem is caused in which it takes time for the design.

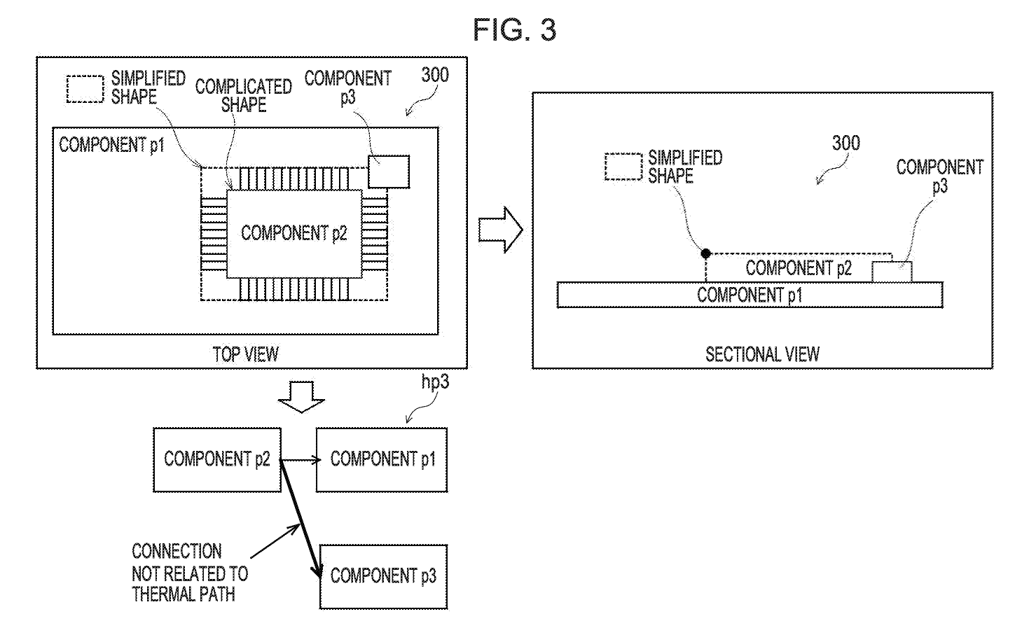

In addition, as described later, there is a case in which components are represented by simplified shapes as illustrated in FIG. 3, for example, at the initial design stage. If two components are represented by the simplified shapes, there is a case in which it is determined that the two components are in contact with each other and a partial route between the two components is undesirably included in a thermal path, even when there is no contact between the two components because the components have complicated shapes in practice.

When a partial route, which is not included in the actual thermal path, is included at the time of search for a thermal path, there is a case in which heat that is estimated to be conducted through the partial route is not to be conducted in the actual product. When a margin of the thermal design is small, there is a case in which a specification related to the thermal design of the product is not satisfied in the product after manufacturing.

For example, in an electronic device or the like, the machine design and the electrical design are performed concurrently, but the design works are performed separately, and design data in the machine design and design data in the electrical design are integrated in the end. The design works of the machine design and the electrical design are performed separately, so that there is a case in which component arrangement or a component itself is changed in any of the designs, thereby causing a contact or interference between unintended components.

Thus, according to the embodiment, when a ratio between an area of a contact surface, which is in contact with a second component, among the surfaces of a first component and an area of a contact portion of the contact surface is less than a reference value, the information processing device 100 determines that the first and second components are not in connection with each other and excludes a partial route between the components from the thermal path. As a result, even when two components, which are highly probably not in contact with each other in practice, are in contact with each other in the simulation space, the information processing device 100 may exclude a partial route between the two components from the thermal path. Thus, the man-hours of the designer, which is related to the thermal path, may be reduced. The reliability of the generated thermal path may be improved.

The information processing device 100 acquires, from among a plurality of surfaces of a first component included in the plurality of components in the simulation space, a contact surface at least a part of which is in contact with a second component included in the plurality of components. The information processing device 100 calculates a ratio between an area of the contact surface and an area of the part, which is in contact with the second component, in the contact surface. In FIG. 1, the plurality of components as design targets are a component a1, a component a2, and a component a3. For example, it is assumed that the first component is the component a1, and the second component is the component a2. In design example_1 and design example_2 of the FIG. 1, the component a1 is mounted on the component a3, and the component a2 is mounted on the component a1.

A plurality of surfaces of the component a1 is, for example, the respective surfaces of a minimum cuboid enclosing the component a1. The component a1 has, for example, six surfaces in total including a surface s1, a surface s2, a surface s3, and the other not-illustrated three surfaces. In the design example_1 and design example_2 of FIG. 1, the surface s1 of the component a1 is in contact with the component a2, and is referred to as a contact surface. The contact surface is also referred to as an interference surface. The area ratio to be calculated is, for example, “area of the contact portion/area of the contact surface”.

In the design example_1, the component a2 is mounted on the whole surface s1 of the component a1. Therefore, the area of the surface s1 is “100”, and the area of a contact portion of the surface s1, which is in contact with the component a2, is “100”. In the design example_1, the area ratio is “100/100” that is “1”.

On the other hand, in the design example_2, the component a2 is mounted on the edge of the surface s1 of the component a1. Therefore, the area of the surface s1 is “100”, and the area of a contact portion of the surface s1, which is in contact with the component a2, is “10”. In the design example_2, the area ratio is “10/100” that is “0.1”.

The information processing device 100 determines whether the calculated ratio is a reference value or more. For example, when the calculated ratio is the reference value or more, the information processing device 100 determines that the first and second components are in connection with each other. For example, when the calculated ratio is less than the reference value, the information processing device 100 determines that the first and second components are not in connection with each other. The reference value is defined by the designer in advance. The reference value may be provided for each of the plurality of surfaces of the first component.

Here, for example, it is assumed that the reference value is “0.6”. In the design example_1, the information processing device 100 determines that the first and second components are in connection with each other because the calculated area ratio is the reference value or more. In the design example_2, the information processing device 100 determines that the first and second components are not in connection with each other because the calculated area ratio is less than the reference value.

The information processing device 100 generates information indicating a thermal path including a partial route between the first and second components when the information processing device 100 determines that the area ratio is the reference value or more, and generates information indicating a thermal path not including the partial route between the first and second components when the information processing device 100 determines that the area ratio is less than the reference value. The information indicating the thermal path is, for example, referred to as thermal path information 101, connection component information, or the like.

In the design example_1, the information processing device 100 generates, for example, thermal path information 101-1 indicating a thermal path n1 including a partial route between the components a1 and a2. In the design example_2, the information processing device 100 generates, for example, thermal path information 101-2 indicating a thermal path n2 not including the partial route between the components a1 and a2.

A description of a partial route between the components a1 and a3 is omitted herein, but whether the partial route between the components a1 and a3 is caused to be included in the thermal path is determined based on a result of a determination, based on the area ratio, of whether the components a1 and a3 are in connection with each other, similar to the partial route between the components a1 and a2.

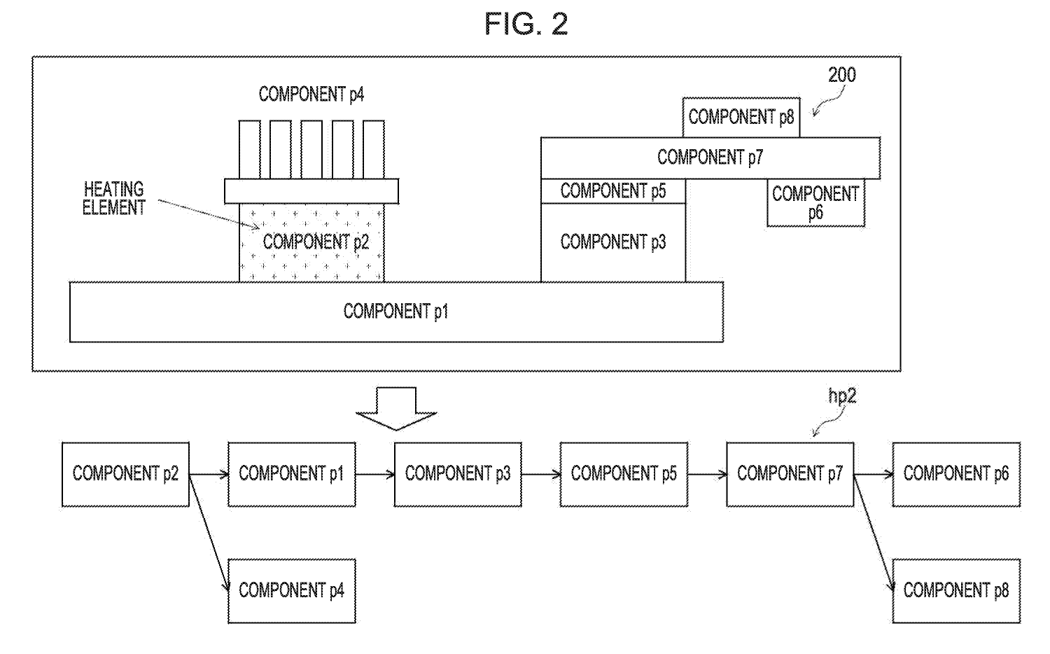

FIG. 2 is a diagram illustrating an example of a thermal path. An electronic device 200 that is a design target includes, for example, components p1 to p8. When the component p2 is a heating element, a thermal path hp2 indicates a route of the components through which heat of the component p2 moves. The thermal path hp2 indicates that, for example, the heat moves from the component p2 to the component p1 and p4. The thermal path hp2 also indicates that, for example, the heat of the component p2 moves from the component p1 to the component p3, from the component p3 to the component p5, from the component p5 to the component p7, and from the component p7 to the component p6 and the component p8.

FIG. 3 is a diagram illustrating an example of a contact, which is not related to a thermal path, at an initial design stage. Here, an example is described in which a thermal path is created at the initial design stage. A top view of an electronic device 300 is illustrated on the left side of FIG. 3, and a sectional view of the electronic device 300 is illustrated on the right side of FIG. 3. In the example of FIG. 3, the electronic device 300 includes components p1, p2, and p3.

At the initial design stage, components such as a printed-circuit board and a mounted component are represented by simplified shapes. The component p1 is, for example, a substrate. The component p2 is, for example, a dual inline package (DIP) that accommodates a semiconductor integrated circuit and the like. The component p3 is a peripheral component of the component p2.

In the case of the initial design stage, each of the components is represented by a simplified shape, so that the component p2 is represented by a rectangle shape. Therefore, when a thermal path is created based on a contact relationship between the components at the initial design stage, it is determined that the component p2 and the component p3 are in connection with each other. Thus, as illustrated on the lower side of in FIG. 3, a thermal path hp3 includes a route from the component p2 to the component p3.

However, in practice, the component p2 that includes a plurality of terminal pins and has a complicated shape, so that, as illustrated on the left side of FIG. 3, the component p2 and the component p3 are not in contact with each other. Therefore, when the thermal path is formed by determination of whether the components are in contact with each other at the initial design stage, there is a case in which an incorrect route is included in the thermal path.

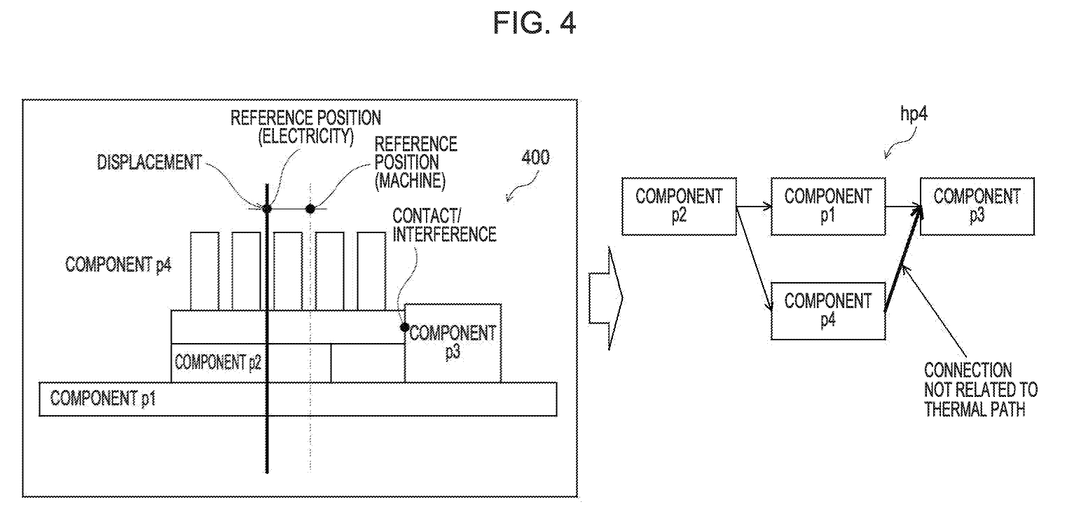

FIG. 4 is a diagram illustrating an example of a contact, which is not related to a thermal path, at the detailed design stage. Here, an example is described in which the thermal path is created at the detailed design stage. In the example of FIG. 4, an electronic device 400 includes, for example, components p1 to p4.

For example, in the electronic device 400 or the like, the machine design and the electrical design are performed concurrently, but the design works are performed separately, and design data in the machine design and design data in the electrical design are integrated in the end. The design works are performed separately, so that there is a case in which component arrangement or a component itself is changed, thereby causing a contact or interference between unintended components.

For example, the component p1, the component p2, and the component p3 are components in the electrical design, but the component p4 is a component in the machine design such as the housing design and the like. When the design data of the component p1, the component p2, and the component p3 and the design data of the component p4 are integrated, there is a case in which a contact or interference occurs between the components p4 and p3 unintentionally due to a displacement of the component p4. For example, the electrical design is performed so that the reference position of the component p4 is arranged at the position of the solid line, but the machine design is performed so that the reference position of the component p4 is arranged at the position of the broken line. Therefore, when the design data of the electrical design and the design data of the machine design are integrated, a displacement of the component p4 occurs.

Therefore, a contact or interference does not occur between the components p4 and p3 in practice, but a thermal path hp4 includes partial routes such as, for example, from the component p2 to the component p1 and the component p4, from the component p1 to the component p3, and from the component p4 to the component p3. Thus, there is a case in which a partial route between the components p4 and p3, which is not included in the thermal path hp4 in practice, is included in the thermal path hp4.

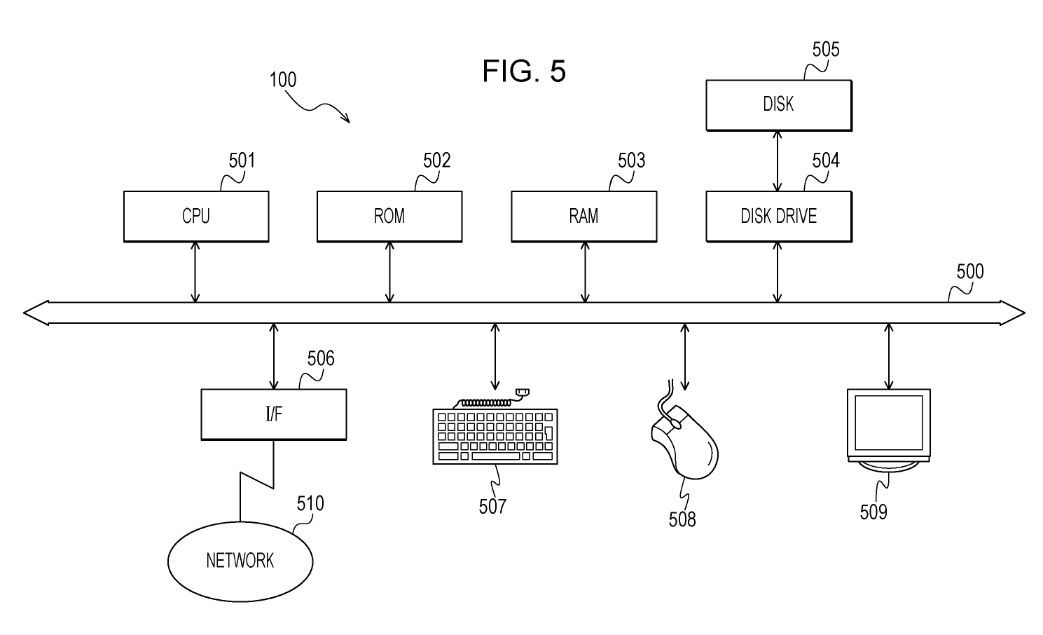

FIG. 5 is a diagram illustrating an exemplary hardware configuration of the information processing device. A case in which the information processing device 100 is a personal computer (PC) is described as an example.

The information processing device 100 includes a central processing unit (CPU) 501, a read-only memory (ROM) 502, and a random access memory (RAM) 503. The information processing device 100 further includes a disk drive 504, a disk 505, an interface (I/F) 506, a keyboard 507, a mouse 508, and a display 509. In addition, the CPU 501, the ROM 502, the RAM 503, the disk drive 504, the I/F 506, the keyboard 507, the mouse 508, and the display 509 are coupled to each other through a bus 500.

The CPU 501 is responsible for the control of the whole information processing device 100. The ROM 502 stores therein programs such as a boot program and a design support program. The RAM 503 is used as a work area of the CPU 501. The disk drive 504 controls read/write of data for the disk 505 in accordance with the control of the CPU 501. The disk 505 stores therein data written by the control of the disk drive 504. Although not illustrated, the disk 505 may store therein, for example, a program such as the design support program. As the disk 505, there is a magnetic disk, an optical disk, or the like. The CPU 501 reads the design support program stored in the ROM 502, the disk 505, or the like and executes processing coded into the design support program.

The I/F 506 is coupled to a network 510 such as a local area network (LAN), a wide area network (WAN), or the Internet through a communication line, and coupled to another device through the network 510. The I/F 506 is responsible for an interface between the network 510 and the inside, and controls input/output of data from/to an external device. As the I/F 506, for example, a modem, a LAN adapter, or the like may be employed.

The keyboard 507 and the mouse 508 are interfaces each of which performs input of various pieces of data in response to a user's operation. The display 509 is an interface that outputs data in response to an instruction of the CPU 501.

In addition to the above-described configuration units, the information processing device 100 may include an input device that takes in an image and a video from a camera or an input device that takes in a sound from a microphone. In addition to the above-described configuration units, the information processing device 100 may include an output device such as a printer. In addition to the above-described configuration units, the information processing device 100 may include, for example, a solid state drive (SSD) and a semiconductor memory.

In the embodiment, a PC is described as an example of the information processing device 100, but the information processing device 100 is not particularly limited to such an example and a server, for example, may be employed. When the information processing device 100 is a server, the display 509 and a device allowed to be operated by the user may be coupled to the information processing device 100 through the network 510. The information processing device 100 may be applied, for example, to a virtual desktop infrastructure (VDI) system or the like. For example, the server executes the processing by the information processing device 100, and a client terminal displays a screen corresponding to the processing.

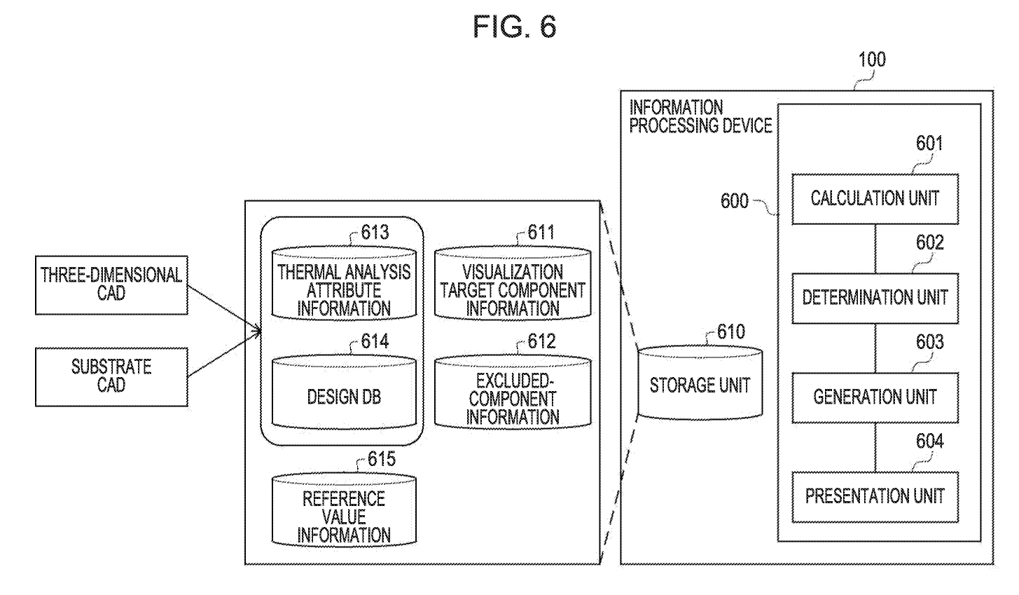

FIG. 6 is a diagram illustrating an exemplary functional configuration of the information processing device. The information processing device 100 includes a calculation unit 601, a determination unit 602, a generation unit 603, a presentation unit 604, and a storage unit 610. For example, pieces of processing of a control unit 600, such as the calculation unit 601 to the presentation unit 604, are coded into a program stored in a storage device accessible by the CPU 501 illustrated in FIG. 5, such as the ROM 502, the RAM 503, or the disk 505. The CPU 501 reads the program from the storage device, and executes the pieces of processing coded into the program. As a result, the pieces of processing of the control unit 600 are achieved. The processing results of the control unit 600 are stored, for example, in the storage device such as the RAM 503, the ROM 502, or the disk 505.

The storage unit 610 is, for example, a storage device such as the RAM 503, the ROM 502, or the disk 505. The storage unit 610 stores therein, for example, pieces of information such as a graphical user interface (GUI) instruction and a file description.

Specifically, the storage unit 610 stores therein, for example, visualization target component information 611, excluded-component information 612, thermal analysis attribute information 613, a design database (DB) 614, reference value information 615, and the like.

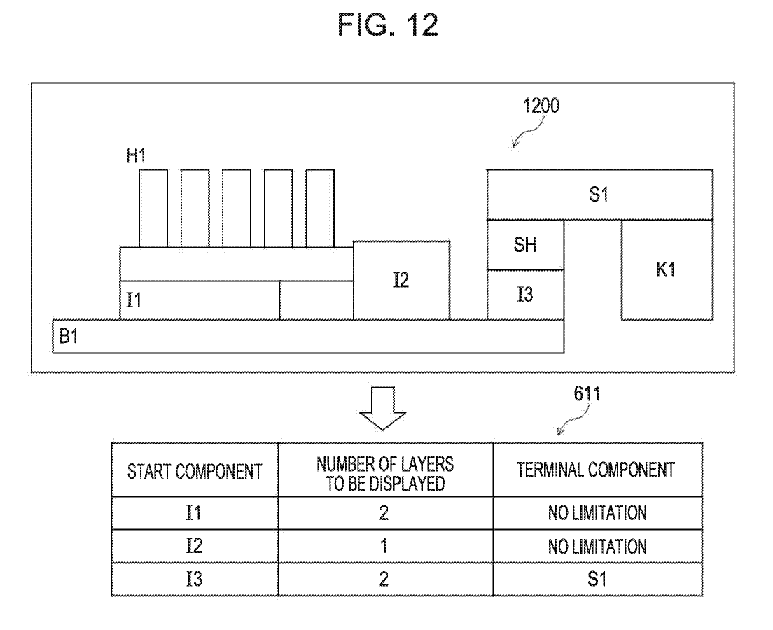

The visualization target component information 611 includes information indicating the number of layers to be displayed, and a start component of a thermal path among a plurality of components of a design target specified by the developer. The detailed example of the visualization target component information 611 is described later with reference to FIG. 12.

The excluded-component information 612 is information indicating a component that is to be excluded from the thermal path. As the excluded component, for example, there is a small component such as a clasp.

The design DB 614 is, for example, information indicating a model of a three-dimensional product designed by three-dimensional CAD or substrate CAD. The design DB 614 includes information such as coordinate information of a polygon for each of the components and information on the positions, the colors, and the like of the components in the simulation space. The thermal analysis attribute information 613 is, for example, information including an index value indicating an ease of conducting heat, for each of the components. As the index value indicating the ease of conducting heat, for example, there is a heat conductivity or the like.

Next, the calculation unit 601 acquires, from among a plurality of surfaces of a first component included in the plurality of components in the simulation space, a contact surface at least a part of which is in contact with a second component included in the plurality of components. Then, the calculation unit 601 calculates a ratio between an area of the contact surface and an area of the part, which is in contact with the second component, in the contact surface. Thereafter, the determination unit 602 determines whether the calculated ratio is a reference value or more.

In the embodiment, for each of the components, it is assumed that a minimum cuboid enclosing the component corresponds to the shape of the component. Specifically, the calculation unit 601 determines whether interference occurs between the first and second components, by performing an interference check. The interference check is checking of overlapping between the shapes of the plurality of components included in the product in the simulation space.

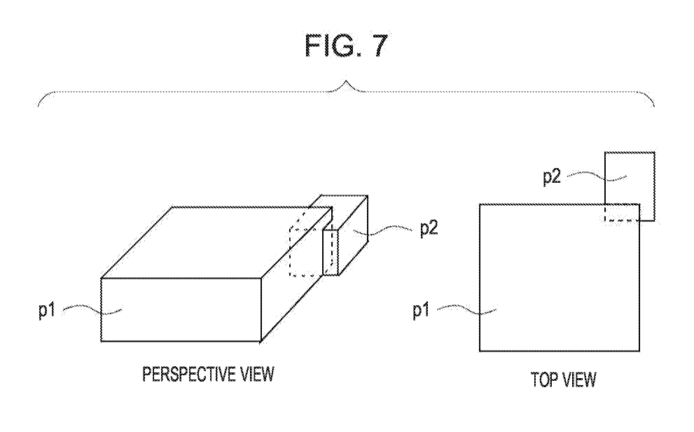

FIG. 7 is a diagram illustrating an example in which interference occurs between components. In FIG. 7, whether interference occurs between components p1 and p2 is illustrated by a perspective view and a top view. A description is made below using the component p1 as the first component and using the component p2 as the second component. From among the surfaces included in the component p1, the calculation unit 601 extracts, as an interference surface, a surface that is in contact with any of the surfaces included in the component p2. In addition, from among the surfaces included in the component p2, the calculation unit 601 extracts, as an interference surface, a surface that is in contact with any of the surfaces included in the component p1.

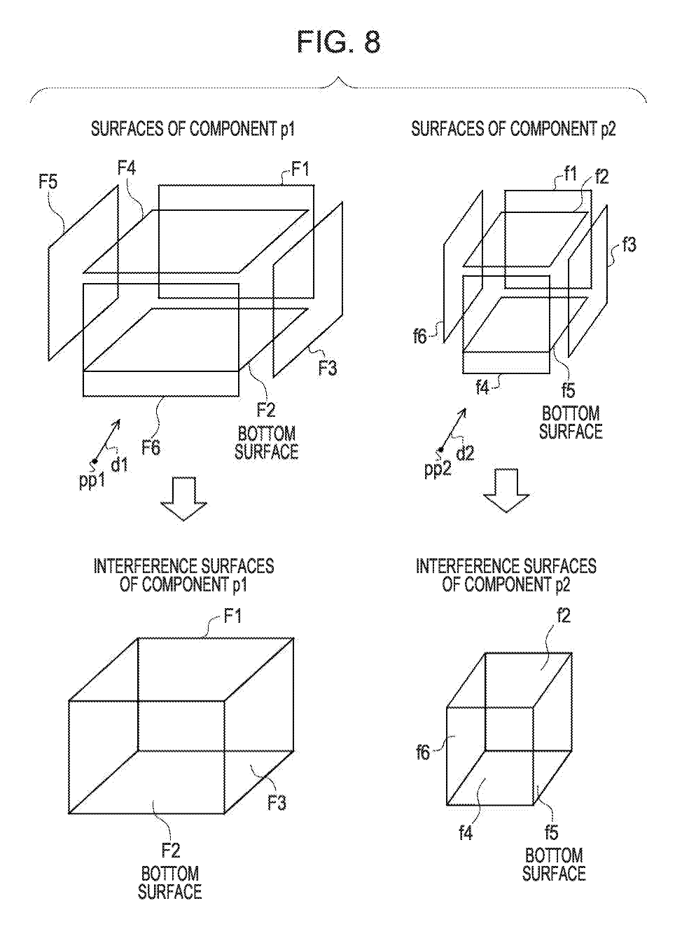

FIG. 8 is a diagram illustrating examples of interference surfaces. The component p1 includes surfaces F1 to F6. For example, the surface F1 is a back surface when the component p1 is viewed from a position pp1 in a direction d1. The surface F2 is a bottom surface when the component p1 is viewed from the position pp1 in the direction d1. The surface F3 is a surface on the right side of the component p1 when the component p1 is viewed from the position pp1 in the direction d1.

The surface F4 is a top surface when the component p1 is viewed from the position pp1 in the direction d1. The surface F5 is a surface on the left side of the component p1 when the component p1 is viewed from the position pp1 in the direction d1. The surface F6 is a front surface when the component p1 is viewed from the position pp1 in the direction d1.

The component p2 includes surfaces f1 to f6. For example, the surface f1 is a back surface when the component p2 is viewed from a position pp2 in a direction d2. The surface f2 is a top surface when the component p2 is viewed from the position pp2 in the direction d2. The surface f3 is a surface on the right side of the component p2 when the component p2 is viewed from the position pp2 in the direction d2.

The surface f4 is a front surface when the component p2 is viewed from the position pp2 in the direction d2. The surface f5 is a bottom surface when the component p2 is viewed from the position pp2 in the direction d2. The surface f6 is a surface on the left side of the component p2 when the component p2 is viewed from the position pp2 in the direction d2.

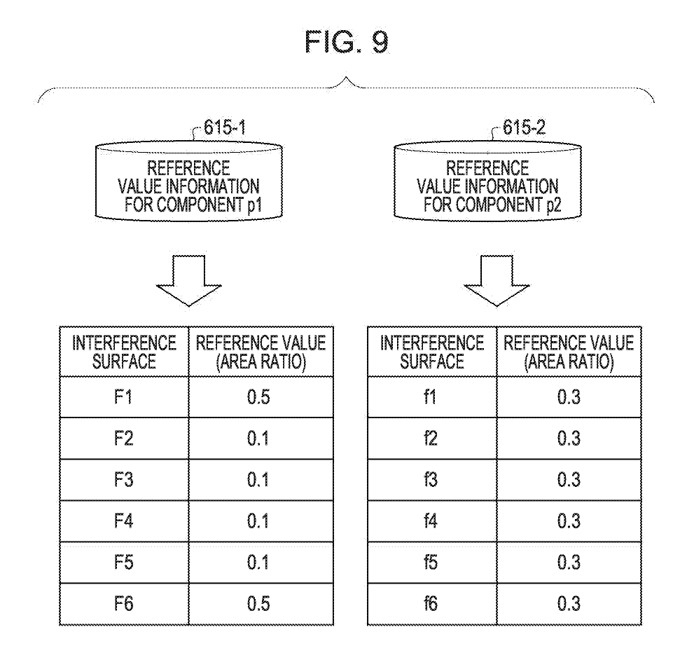

FIG. 9 is a diagram illustrating examples of the reference value information. The reference value information 615 is used to determine, for example, whether two components are in connection with each other. For example, in the pieces of reference value information 615 such as reference value information 615-1 for the component p1 and reference value information 615-2 for the component p2, reference values may be respectively defined for a plurality of components. In addition, reference values may be defined for the respective surfaces of the component.

For example, in the reference value information 615-1, a reference value of an area ratio is set in advance for the respective surfaces of the component p1. For example, in the reference value information 615-2, a reference value of an area ratio is set in advance for the respective surfaces of the component p2.

When an interference surface is identified, the determination unit 602 obtains an area ratio that is a reference value for the interference surface from the reference value information 615-1.

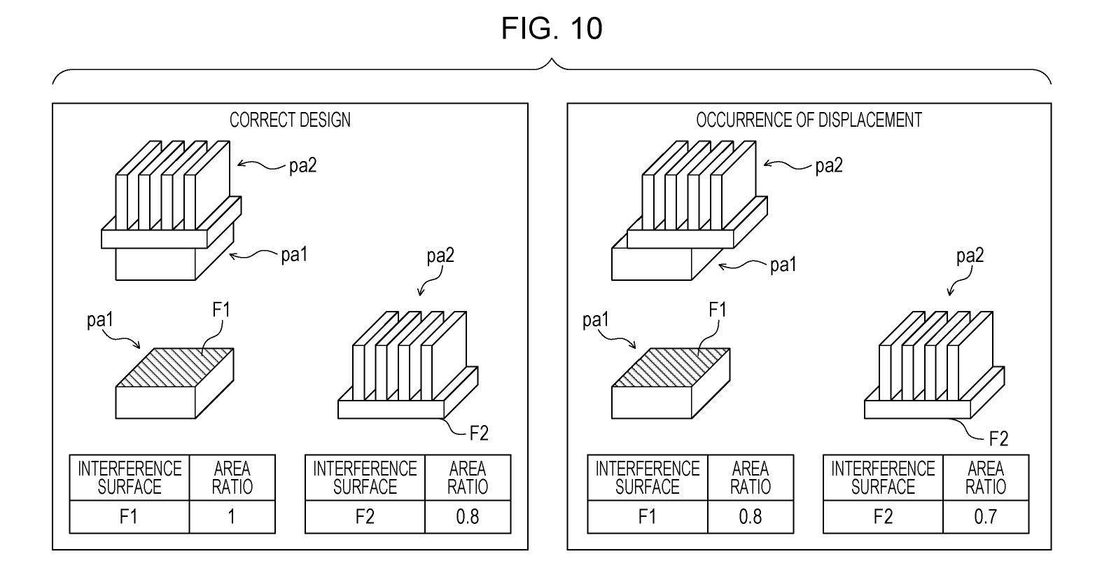

FIG. 10 is a diagram illustrating exemplary designs and a corresponding area ratio for each surface. A component pa2 is mounted on a component pa1 in the exemplary design. On the left side of FIG. 10, the component pa2 is mounted correctly on the component pa1. On the right side of FIG. 10, the component pa2 is mounted on the component pa1 with displacement.

In the example on the left side of FIG. 10, an interference surface F1 of the component pa1 is smaller than an interference surface F2 of the component pa2, and the whole surface of the interference surface F1 is covered by the interference surface F2 of the component pa2. An area ratio between an area of the interference surface F1 of the component pa1 and an area of a portion of the interference surface F1 of the component pa1, which is in contact with the interference surface F2 of the component pa2, is “1.0”. In the example on the left side of FIG. 10, the interference surface F2 of the component pa2 is in contact with the interference surface F1 of the component pa1, but not the whole interference surface F2 is covered by the interference surface F1. Therefore, an area ratio between the area of the interference surface F2 of the component pa2 and an area of a portion of the interference surface F2 of the component pa2, which is in contact with the interference surface F1 of the component pa1, is “0.8”.

On the other hand, in the example on the right side of FIG. 10, not the whole interference surface F1 of the component pa1 is covered by the interference surface F2 of the component pa2 due to the displacement. Therefore, the area ratio between the area of the interference surface F1 of the component pa1 and the area of a portion of the interference surface F1 of the component pa1, which is in contact with the interference surface F2 of the component pa2, is “0.8”. The area ratio between the area of the interference surface F2 of the component pa2 and the area of the portion of the interference surface F2 of the component pa2, which is in contact with the interference surface F1 of the component pa1, is “0.7”. As described above, in the example on the right side of FIG. 10, each of the area ratios becomes smaller due to the displacement as compared with the example on the left side of FIG. 10.

As an area ratio for an interference surface of a component become larger, a probability in which a connection occurs between components becomes higher, and as the area ratio for the interference surface of the component become smaller, a probability in which a connection occurs between components becomes lower.

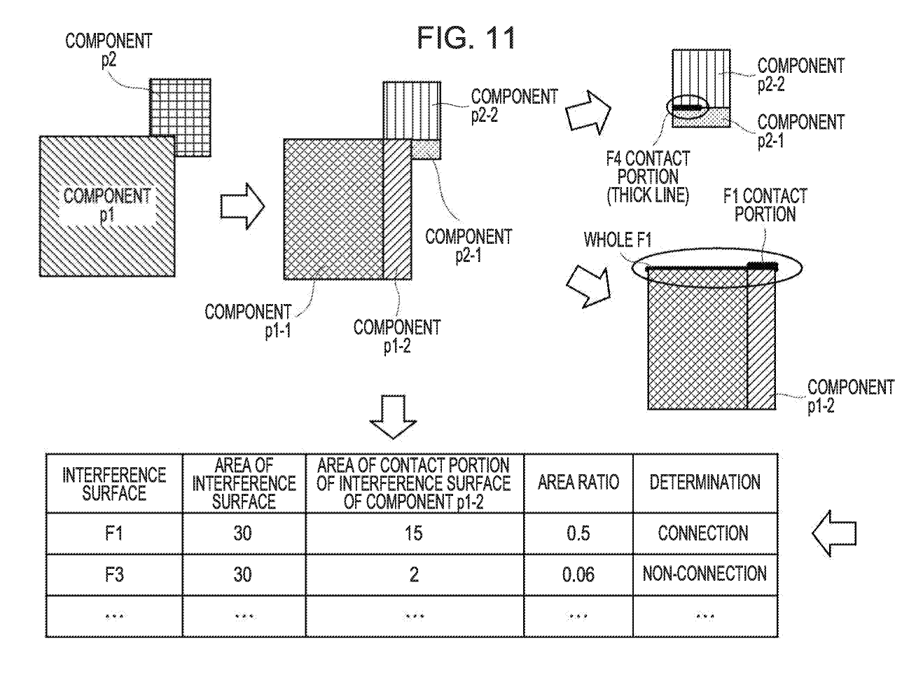

FIG. 11 is a diagram illustrating examples of calculation and determination of an area ratio. With reference to FIG. 11, the description returns to the calculation of the area ratio for the interference surface of the component p1 illustrated in FIG. 7. Here, a top view of the components p1 and p2 is used. Here, for ease of explanation, the component p1 is divided into a component p1-2 of a portion that is in contact with the component p2 and a component p1-1 of a portion that is not in contact with the component p2. The component p2 is divided into a component p2-1 of a portion that is in contact with the component p1 and a component p2-2 of a portion that is not in contact with the component p1.

An area of the interference surface F1 of the component p1 is “30”. An area of the contact portion of the interference surface F1 in the component p1-2 is “15”. Therefore, the calculation unit 601 calculates the area ratio for the interference surface F1 of the component p1 as “0.5”. Next, the determination unit 602 determines whether the area ratio “0.5” is the reference value or more. The reference value of the interference surface F1 illustrated in FIG. 9 is “0.5”. The determination unit 602 determines that a connection occurs in the interference surface F1 because the area ratio “0.5” is the reference value or more.

In addition, an area of an interference surface F3 of the component p1 is “30”. An area of a contact portion of the interference surface F3 in the component p1-2 is “2”. Therefore, the calculation unit 601 calculates an area ratio for the interference surface F3 of the component p1 as “0.06”. Next, the determination unit 602 determines whether the area ratio “0.06” is the reference value or more. The reference value of the interference surface F3 illustrated in FIG. 9 is “0.1”. The determination unit 602 determines that a connection does not occur for the interference surface F3 because the area ratio “0.06” is less than the reference value. Although not illustrated, the calculation unit 601 calculates the area ratio for the interference surface F2 similarly.

When it is determined that a connection occurs in one of interference surfaces of the component p1, the determination unit 602 determines that the component p1 is in connection with the component p2. When it is determined that there is no connection for all of the interference surfaces of the component p1, the determination unit 602 determines that the component p1 is not in connection with the component p2. In the example of FIG. 11, it is determined that a connection occurs in the interference surface F1.

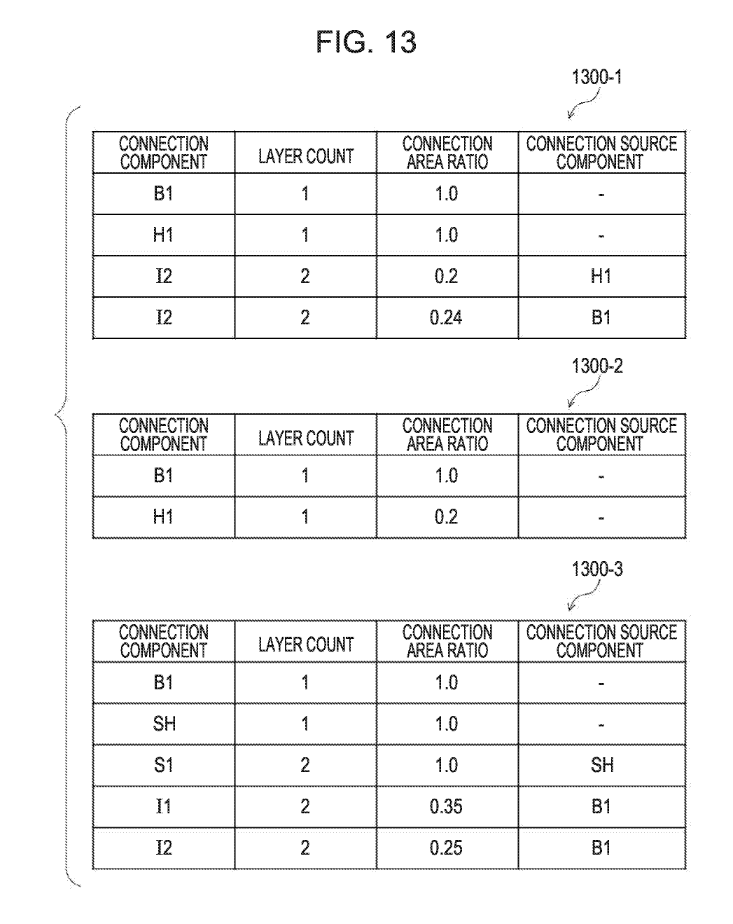

Next, when it is determined that an area ratio is a reference value or more in any one of the interference surfaces, the generation unit 603 generates information indicating a thermal path including a partial route between the first and second components. When it is determined that an area ratio is less than a reference value in all of the interference surfaces, the generation unit 603 generates information indicating a thermal path not including the partial route between the first and second components. The information indicating the thermal path is, for example, a connection component information described later with reference to FIG. 13.

The determination unit 602 detects, for example, the largest area ratio, from among the area ratios for the interference surfaces in each of which a connection is determined to occur. The determination unit 602 may finally determine that the component p1 is in connection with the component p2 by determining whether the largest area ratio is a certain reference value or more, which is defined by the user in advance. The certain reference value is also referred to as, for example, the whole reference value. Here, it is assumed that the whole reference value is, for example, “0.3”. The detected area ratio “0.5” is the whole reference value “0.3” or more, so that the determination unit 602 determines that the component p1 is in connection with the component p2.

When it is determined that the largest area ratio is the whole reference value or more, the generation unit 603 generates information indicating a thermal path including a partial route between the first and second components. When it is determined that the largest area ratio is less than the whole reference value, the generation unit 603 generates information indicating a thermal path not including the partial route between the first and second components. The information indicating the thermal path is, for example, the connection component information described later with reference to FIG. 13.

A GUI is described below. For example, in the information processing device 100, the user may specify a start component of a thermal path. The information processing device 100 may sequentially identify connection components, for example, starting from the start component, and create information on the thermal path.

FIG. 12 is a diagram illustrating an example of the visualization target component information. In the visualization target component information 611, pieces of information on a start component, a layers to be displayed in a thermal path, a terminal component of the thermal path, and the like specified by the user are set. A product 1200 that is a design target includes, for example, a component B1, components I1, a component H1, a component I2, a component I3, a component SH, a component S1, and a component K1.

The visualization target component information 611 includes, for example, information on a start component of the thermal path that is specified by the user and the like from among a plurality of components included in the product 1200.

The visualization target component information 611 includes, for example, fields of a start component, a layers to be displayed, and a terminal component. To the field of the start component, for example, a name of the start component of the thermal path that is specified by the designer from among the plurality of components included in the product is set as identification information. To the field of the layers to be displayed, for example, the number of components traced from the start component in the thermal path is set. To the field of the terminal component, a name of a terminal component displayed from the start component in the thermal path is set. The fields set with the pieces of information are stored as a record.

FIG. 13 is a diagram illustrating examples of connection component information. Connection component information 1300 in the examples of FIG. 13 is information indicating a thermal path for each of the start components illustrated in FIG. 12. In the connection component information 1300, pieces of information on connection components in each of which the determination unit 602 determines that a connection occurs is registered.

The connection component information 1300 includes, for example, fields of a connection component, a layer count, a connection area ratio, and a connection source component. Information is set to each of the fields, and the connection component information 1300 is stored, for example, in the storage unit 610 or the like.

To the field of the connection component, a name of a connection component is set. To the field of the layer count, the number of components counted from the start component in the thermal path is set. To the field of the connection source component, a name of a component (connection source component) preceding the connection component in the thermal path is set. When the layer count is “1”, the connection source component is the start component, so that the connection source component is not necessarily registered in the connection component information 1300. To the field of the connection area ratio, the maximum value of an area ratio between an area of an interference surface of the connection source component and an area of a portion of the interference surface of the connection source component, which is in contact with the connection component, is set.

Connection component information 1300-1 is information indicating a thermal path in which the component I1 is set as a start component. In the visualization target component information 611 illustrated in FIG. 12, the number of the layers to be displayed for the component I1 are “2”. In the connection component information 1300-1, the component B1 and the component H1 are registered as connection components with the layer count of “1”.

As described above, the connection area ratio for the component B1 is an area ratio between an area of an interference surface of the component I1 and an area of a portion of the interference surface of the component I1, which is in contact with an interference surface of the component B1. Here, the interference surface of the component I1 is one of the surfaces of a portion in which interference occurs with the component B1, and the connection area ratio for the component B1 is the largest area ratio from among the area ratios calculated for the respective interference surfaces of the component I1 as described above. In the following example, in a description of “interference surface of the component”, similar surfaces or similar area ratios are indicated. As illustrated in FIG. 12, the whole interference surface on the lower side of the component I1 is in contact with the component B1, so that “1.0” is set to the connection area ratio for the component B1 in the connection component information 1300-1 illustrated in FIG. 13.

In addition, as illustrated in FIG. 12, the whole interference surface on the upper side of the component I1 is in contact with the interference surface of the component H1, so that “1.0” is set to the connection area ratio for the component H1 in the connection component information 1300-1 illustrated in FIG. 13.

Next, in FIG. 12, the component B1 is in contact with the component I2 and the component I3. The connection area ratio for the component I2 is, for example, an area ratio between an area of the interference surface of the component B1 and an area of a portion of the interference surface of the component B1, which is in contact with the interference surface of the component I2. The connection area ratio for the component I2 is, for example, “0.24”. The connection area ratio for the component I3 is, for example, an area ratio between an area of the interference surface of the component B1 and an area of a portion of the interference surface of the component B1, which is in contact with the interference surface of the component I3. The connection area ratio for the component I3 is, for example, “0.15”.

Here, it is assumed that a reference value for the interference surface of the component B1 or a whole reference value is “0.2”. The above-described connection area ratio for the component I2 is the reference value or more, so that it is determined that the component B1 and the component I2 are in contact with each other. Therefore, in the connection component information 1300-1, information on the component I2 is registered in association with the component B1 as the connection source component thereof. On the other hand, the area ratio between the component B1 and the component I3 is less than the reference value, so that it is determined that the component B1 and the component I3 are not in contact with each other. Therefore, in the connection component information 1300-1, information on the component I3 is not registered.

As described above, when it is determined that a connection does not occur between the connection components by the determination on the area ratio, the connection component is not registered in the connection component information 1300 indicating the thermal path, and excluded from the thermal path.

As described above, the number of the layers to be displayed for the component I1 is “2”, so that a thermal path beyond the component I2 with the layer count of “2” is not searched for.

Next, the connection component information 1300-2 is information indicating a thermal path in which the component I2 is set as a start component. In the visualization target component information 611 illustrated in FIG. 12, the number of the layers to be displayed for the component I2 is “1”. Therefore, in the connection component information 1300-2, merely pieces of information on connection components each of which is determined to be in connection with the component I2 are registered. The whole interference surface of the component 12 is in contact with the interference surface of the component B1, so that “1.0” is set to the connection area ratio for the component B1 in the connection component information 1300-2. A part of the interference surface of the component I2 is in contact with the interference surface of the component H1, so that “0.2” is set to the connection area ratio for the component H1 in the connection component information 1300-2.

The connection component information 1300-3 is information indicating a thermal path in which the component I3 is set as a start component. According to the visualization target component information 611 illustrated in FIG. 12, the number of the layers to be displayed for the component I3 are “2”, and the terminal component is “S1”. Therefore, in the connection component information 1300-3, pieces of information on connection components each of which is determined to be in connection with the component I3 and connection components each of which is determined to be in connection with the connection component with the layer count of “1” are registered. When a search for the thermal path reaches the terminal component at an intermediate layer other than the last layer of the layers to be displayed, thermal paths beyond the terminal component and other components at the intermediate layer are not searched for.

In FIG. 12, the component I3 is in contact with the component B1 and the component SH. The connection area ratio for the component B1 is, for example, an area ratio between an area of the interference surface of the component I3 and an area of a portion of the interference surface of the component I3, which is in contact with the interference surface of the component B1. The whole interference surface of the component I3 is in contact with the interference surface of the component B1, so that “1.0” is set to the connection area ratio for the component B1 in the connection component information 1300-3.

The connection area ratio for the component SH is, for example, an area ratio between an area of the interference surface of the component I3 and an area of a portion of the interference surface of the component I3, which is in contact with the interference surface of the component SH. The whole interference surface of the component I3 is in contact with the interference surface of the component SH, so that “1.0” is set to the connection area ratio for the component SH in the connection component information 1300-3.

Next, the layer counts of the component B1 and the component SH that are connection components are “1”, and are smaller than the number “2” of the layers to be displayed, so that respective thermal paths beyond the component B1 and the component SH are also searched for.

The component B1 is in contact with the component I2 and the component I1 in addition to the component I3. The connection area ratio for the component I1 is an area ratio between an area of the interference surface of the component B1 and an area of a portion of the interference surface of the component B1, which is in contact with the interference surface of the component I1. A part of the interference surface of the component B1 is in contact with the interference surface of the component I1, so that “0.35” is set to the connection area ratio for the component I1 in the connection component information 1300-3. The connection area ratio for the component I2 is a ratio between an area of an interference surface of the component B1 and an area of a portion of the interference surface of the component B1, which is in contact with the interference surface of the component I2. A part of the interference surface of the component B1 is in contact with the interference surface of the component I2, so that “0.25” is set to the connection area ratio for the component I3 in the connection component information 1300-3.

The component SH is in contact with the component S1, which is specified as a terminal component, in addition to the component I3. The connection area ratio for the component S1 is an area ratio between an area of an interference surface of the component SH and an area of a portion of the interference surface of the component SH, which is in contact with the interference surface of the component S1. The whole interference surface of the component SH is in contact with the interference surface of the component S1, so that “1.0” is set to the connection area ratio for the component S1 in the connection component information 1300-3.

In the connection component information 1300-1, the component B1 is determined not to be in connection with the component I3, and in the connection component information 1300-3, the component I3 is determined to be in connection with the component B1. As described above, whether a connection occurs changes depending on the size of each of the components, so that the user may search for a thermal path by specifying various components as start components to create a plurality of types of thermal paths.

The presentation unit 604 displays a thermal path, for example, based on information indicating the thermal path, which is generated by the generation unit 603. The presentation unit 604 may display the thermal path, for example, on the display 509 or the like. The presentation unit 604 may display partial routes so as to distinguish a partial route having a connection area ratio less than a predetermined value and a partial route having a connection area ratio equal to or more than the predetermined value, at the time of displaying the thermal path. Here, the predetermined value is, for example, a value that is set by the user in advance and is smaller than the above-described whole reference value. Specifically, the presentation unit 604 represents, for example, a partial route having a connection area ratio less than the predetermined value by a dotted line, and a partial route having a connection area ratio equal to or more than the predetermined value by a solid line. For example, it is assumed that the predetermined value is 0.8.

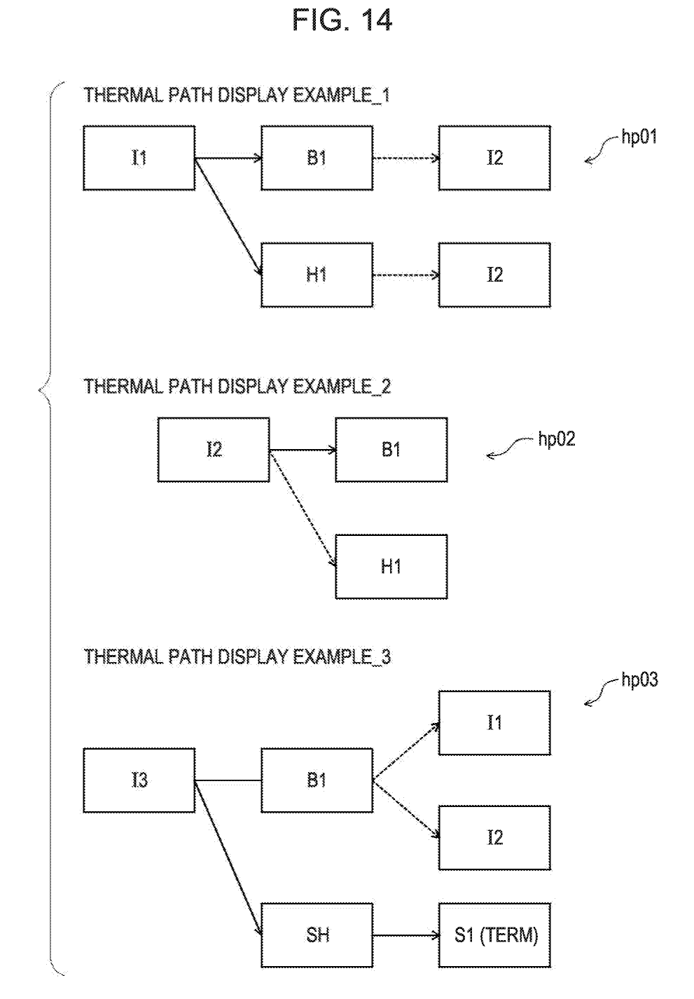

FIG. 14 is a diagram illustrating examples of display of thermal paths. In a thermal path display example_1, a thermal path hp01 indicated by the connection component information 1300-1 is illustrated. In a thermal path display example_2, a thermal path hp02 indicated by the connection component information 1300-2 is illustrated. In a thermal path display example_3, a thermal path hp03 indicated by the connection component information 1300-3 is illustrated.

For example, the thermal path hp01 has the component I1 as the start component, and branches to the component B1 and the component H1. The thermal path hp01 reaches the component I2 via the component B1, and also reaches the component I2 via the component H1. In the connection component information 1300-1, the connection area ratio for the component I2 when the connection source component is the component H1 is “0.2”, which is less than the predetermined value “0.8”, so that a partial route from the component H1 to the component I2 is represented by a dotted line. In addition, in the connection component information 1300-1, the connection area ratio for the component I2 when the connection source component is the component B1 is “0.24”, which is less than the predetermined value “0.8”, so that a partial route from the component B1 to the component I2 is also represented by a dotted line.

The thermal path hp02 has the component I2 as the start component, and branches to the component B1 and the component H1. In the connection component information 1300-2, the connection area ratio for the component H1 is “0.2”, which is less than the predetermined value “0.8”, so that a partial route from the component I2 to the component H1 is represented by a dotted line.

The thermal path hp03 has the component I3 as the start component, and branches to the component B1 and the component SH. The thermal path hp03 branches to the component I1 and the component I2 via the component B1. The thermal path hp03 reaches the component S1 via the component SH.

In the connection component information 1300-3, the connection area ratio for the component I1 is “0.35”, which is less than the predetermined value “0.8”, so that a partial route from the component B1 to the component I1 is represented by a dotted line. In the connection component information 1300-3, the connection area ratio for the component I2 is “0.25”, which is less than the predetermined value “0.8”, so that a partial route from the component B1 to the component I2 is represented by a dotted line.

As described above, a partial route in which it is not highly probable that a contact occurs and a partial route in which it is highly probable that a contact occurs are displayed so as to be distinguished, so that a search for the thermal path by the user may be facilitated.

The presentation unit 604 may display a component so that the component may be recognized as a terminal component. In the example of the thermal path hp03, “(TERM)” is displayed on the name portion of the terminal component.

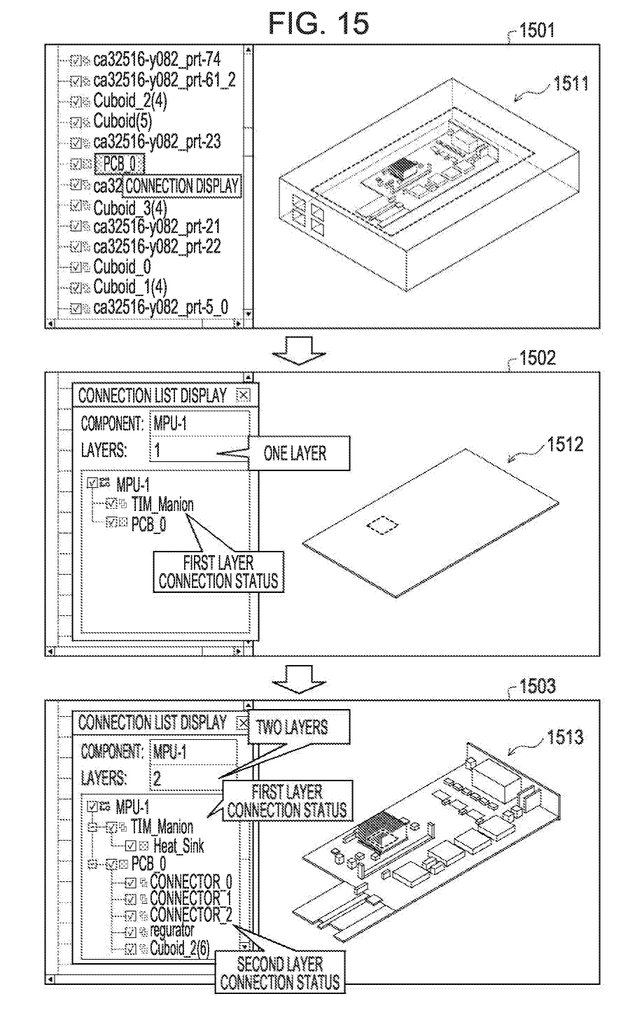

FIG. 15 is a diagram illustrating an example of a screen operation. In a screen 1501, for example, information on a connection related to components selected in a component selection field on the left side of the screen is displayed in a field on the right side of the screen. Specifically, in the screen 1501, a path 1511 indicating the whole connection relationship is displayed in the field on the right side of the screen.

A screen 1502 includes, for example, fields to which a user may set parameters, specifically, a field for setting a name of a start component for which a thermal path is to be displayed and a field for setting the number of layers to be displayed. The screen 1502 is an example in which “MPU-1” is set as the start component and “1” is set as the number of the layers to be displayed. A thermal path 1512 is displayed in the field on the right side of the screen, based on the component “MPU-1” and the number “1” of the layers to be displayed, which are set to the fields on the left side of the screen.

A screen 1503 is an example in which “MPU-1” is set as the start component and “2” is set as the number of the layers to be displayed. A thermal path 1513 is displayed in the field on the right side of the screen, based on the component “MPU-1” and the number “2” of the layers to be displayed, which are set to the fields on the left side of the screen.

In the above-described example, the calculation unit 601 uses, for example, the largest value from among the area ratios calculated for the respective interference surfaces of the connection source component as a final area ratio, but the embodiment is not limited to such an example.

For example, the sizes of the surfaces of the connection source component are respectively different from the sizes of the surfaces of the connection component. Therefore, there may be different determination results between a case in which the presence or absence of a connection between the connection source component and the connection component is determined based on an area ratio for the area of the interference surface of the connection source component and a case in which the presence or absence of the connection between the connection source component and the connection component is determined based on an area ratio for the area of the interference surface of the connection component.

Thus, for example, the calculation unit 601 may calculate the area ratio for each of the interference surfaces of the connection source component while calculating the area ratio for each of the interference surfaces of the connection component.

The determination unit 602 may determine whether the area ratio is a reference value or more, for each of the interference surfaces of the connection source component while determining whether the area ratio is the reference value or more, for each of the interference surfaces of the connection component. As a result, the determination unit 602 may determine whether a connection occurs in each of the interference surfaces of the connection source component and the interference surfaces of the connection component. Next, the determination unit 602 may determine whether a connection occurs between the connection source component and the connection component, for example, by determining whether the largest area ratio, from among the area ratios with which it is determined that a connection occurs, is the final reference value or more.

The surfaces of the component are not limited to the six surfaces of the minimum cuboid enclosing the component. For example, when a component has an accordion shape, the respective surfaces of the accordion portion may be sectioned as the surfaces of the component.

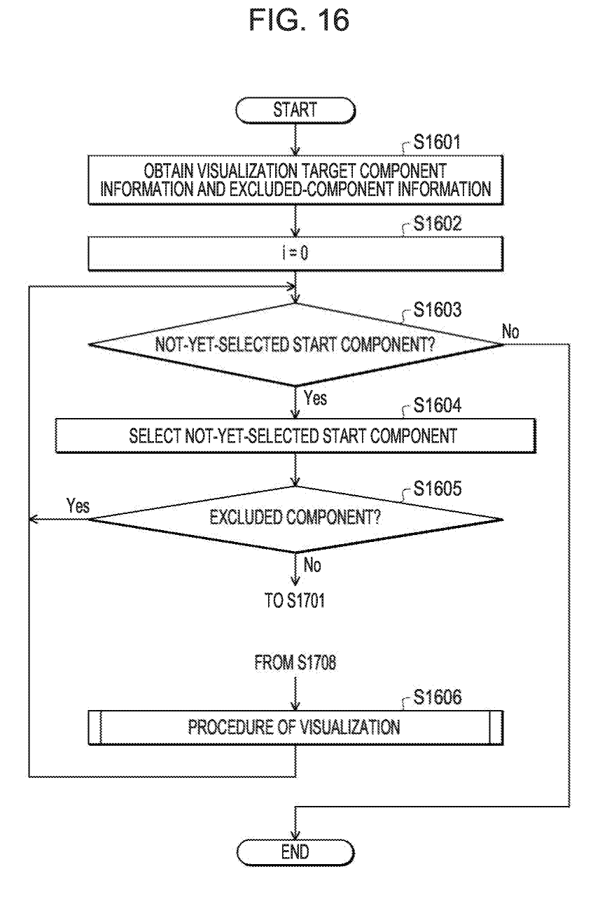

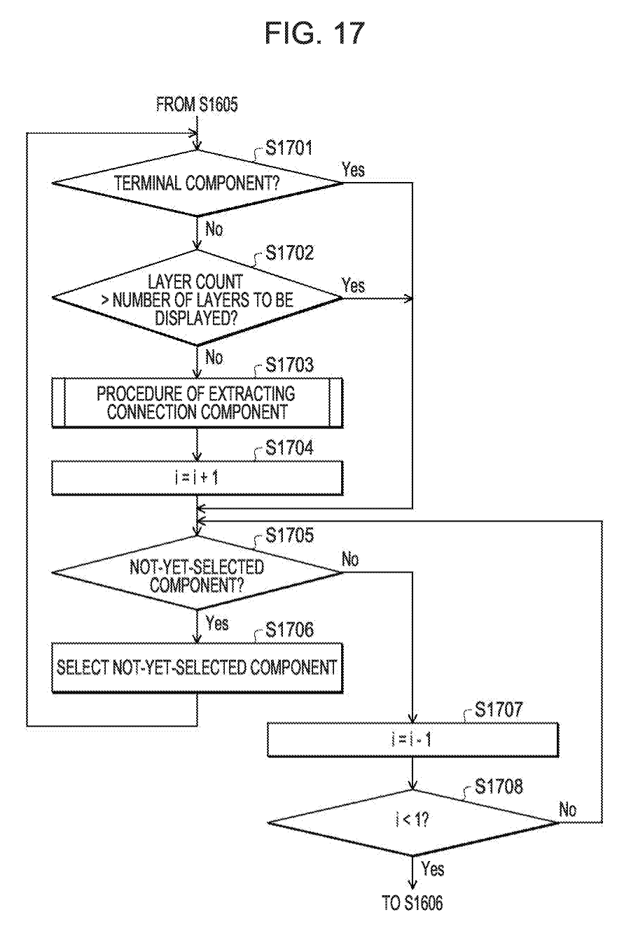

FIGS. 16 and 17 are flowcharts each illustrating an example of a procedure of calculating a thermal path by the information processing device. The information processing device 100 obtains the visualization target component information 611 and the excluded-component information 612 (S1601). The information processing device 100 sets “0” to i (S1602).

The information processing device 100 determines whether there is a start component (not-yet-selected start component) that is not yet selected, for example, in the visualization target component information 611 (S1603). When the information processing device 100 determines that there is at least one not-yet-selected start component (S1603: Yes), the information processing device 100 selects one of the not-yet-selected start components from the visualization target component information 611 as a connection source component (S1604).

The information processing device 100 determines whether the connection source component is an excluded component that is to be excluded from a thermal path (S1605). When the information processing device 100 determines that the connection source component is an excluded component that is to be excluded from a thermal path (S1605: Yes), the information processing device 100 returns to S1603.

When the information processing device 100 determines that the connection source component is not an excluded component that is to be excluded from a thermal path (S1605: No), the information processing device 100 determines whether the connection source component is a terminal component (S1701). When the information processing device 100 determines that the connection source component is a terminal component (S1701: Yes), the information processing device 100 proceeds to S1705.

When the information processing device 100 determines that the connection source component is not a terminal component (S1701: No), the information processing device 100 determines whether the layer count of the connection source component exceeds the number of the layers to be displayed (S1702). When the information processing device 100 determines that the layer count of the connection source component exceeds the number of the layers to be displayed (S1702: Yes), the information processing device 100 proceeds to S1705. When the information processing device 100 determines that the layer count of the connection source component does not exceed the number of the layers to be displayed (S1702: No), the information processing device 100 executes a procedure of extracting a connection component (S1703). The information processing device 100 increments i by “1” (S1704).

The information processing device 100 determines whether there is a component (not-yet-selected component) that is not yet selected in connection components at a layer i (S1705). When the information processing device 100 determines that there is at least one not-yet-selected component in the connection components at the layer i (S1705: Yes), the information processing device 100 selects one of the not-yet-selected components from the connection components at the layer i as a connection source component (S1706), and returns to S1701.

When the information processing device 100 determines that there is no not-yet-selected component in the connection components at the layer i (S1705: No), the information processing device 100 decrements i by “1” (S1707). The information processing device 100 determines whether i is smaller than “1” (S1708). When the information processing device 100 determines that i is not smaller than “1” (S1708: No), the information processing device 100 returns to S1705.

When the information processing device 100 determines that i is smaller than “1” (S1708: Yes), the information processing device 100 executes a procedure of visualization (S1606), and returns to S1603.

When the information processing device 100 determines that there is no not-yet-selected start component (S1603: No), the information processing device 100 ends a series of processing.

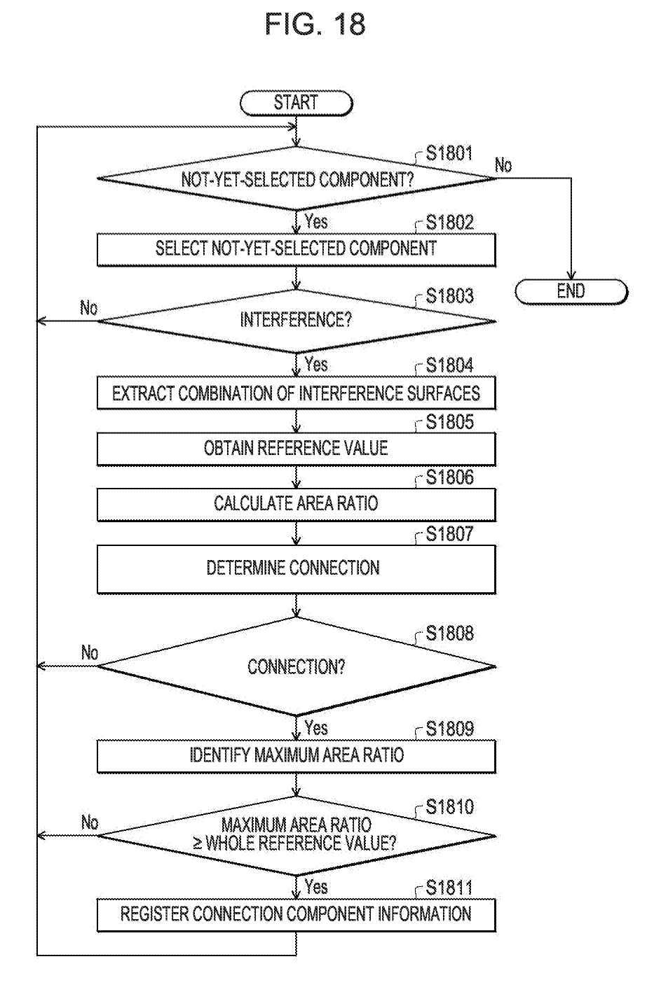

FIG. 18 is a flowchart illustrating an example of the procedure of extracting a connection component. The information processing device 100 determines whether there is a component (not-yet-selected component) that is not yet selected from among components other than excluded components and other than the selected start component (S1801). When the information processing device 100 determines that there is at least one not-yet-selected component (S1801: Yes), the information processing device 100 selects one of the not-yet-selected components (S1802).

The information processing device 100 determines whether interference occurs by performing an interference check between the connection source component and the selected component (S1803). When the information processing device 100 determines that interference does not occur (S1803: No), the information processing device 100 returns to S1801. When the information processing device 100 determines that interference occurs (S1803: Yes), the information processing device 100 extracts a combination of respective interference surfaces of the connection source component and the selected component in the interference portion (S1804).

Next, the information processing device 100 obtains a reference value from area ratio information for each of the interference surfaces of the connection source component (S1805). The information processing device 100 calculates, for each of the interference surfaces of the connection source component, an area ratio between an area of the interference surface and an area of a portion of the interference surface, which is in contact with the selected component (S1806). The information processing device 100 performs connection determination of whether the calculated area ratio for each of the interference surfaces of the connection source component is the reference value or more (S1807). As described above, the information processing device 100 determines that there is a connection when the area ratio is the reference value or more, and determines that there is no connection when the area ratio is less than the reference value.

The information processing device 100 determines whether there is an interference surface in which a connection is determined to occur (S1808). When the information processing device 100 determines that there is no interference surface in which a connection is determined to occur (S1808: No), the information processing device 100 returns to S1801. When the information processing device 100 determines that there is an interference surface in which a connection is determined to occur (S1808: Yes), the information processing device 100 identifies the maximum area ratio, from among the area ratios for the interference surfaces in each of which a connection is determined to occur (S1809).

The information processing device 100 determines whether the maximum area ratio is the whole reference value or more (S1810). When the information processing device 100 determines that the maximum area ratio is the whole reference value or more (S1810: Yes), the information processing device 100 registers the selected component in the connection component information 1300 as a connection component for the connection source component (S1811). When the information processing device 100 determines that the maximum area ratio is less than the whole reference value (S1810: No), the information processing device 100 returns to S1801.

When the information processing device 100 determines that there is no not-yet-selected component (S1801: No), the information processing device 100 ends a series of processing.

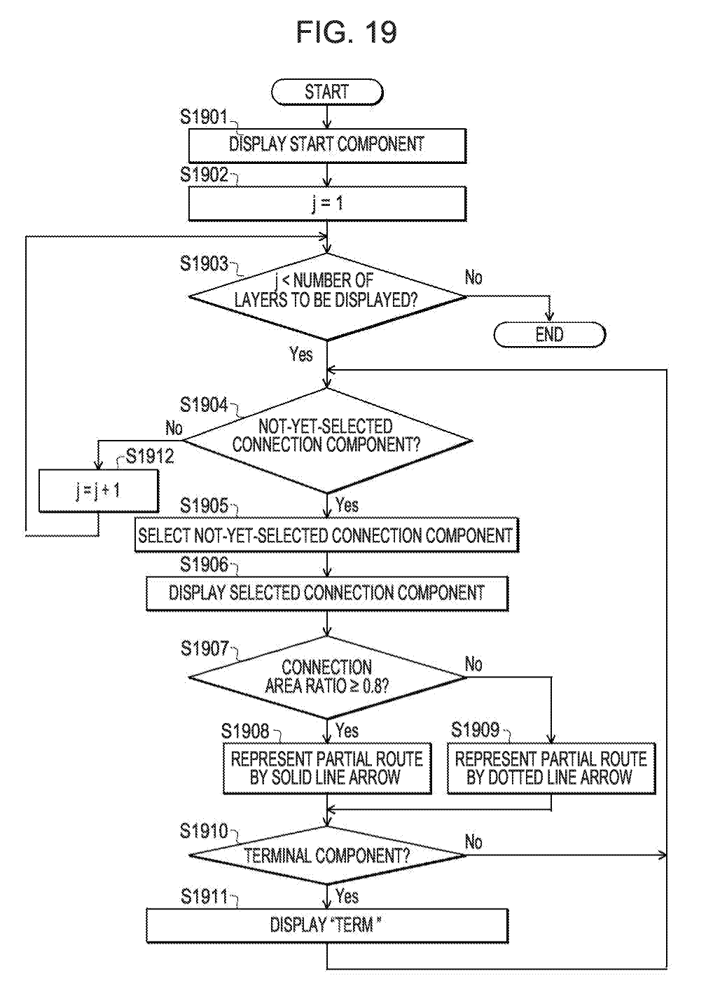

FIG. 19 is a flowchart illustrating an example of a procedure of visualization. First, the information processing device 100 displays a start component with the component name (S1901). The information processing device 100 sets “1” to j (S1902). The information processing device 100 determines whether j is smaller than the number of layers to be displayed (S1903).

When the information processing device 100 determines that j is smaller than the number of layers to be displayed (S1903: Yes), the information processing device 100 determines whether there is a connection component (not-yet-selected connection component) that is not yet selected from among connection components of the layer j (S1904). When the information processing device 100 determines that there is at least one not-yet-selected connection component (S1904: Yes), the information processing device 100 selects one of the not-yet-selected connection components of the layer j (S1905).

The information processing device 100 displays the selected connection component with the component name (S1906). The information processing device 100 determines whether the connection area ratio is 0.8 or more (S1907). When the information processing device 100 determines that the connection area ratio is 0.8 or more (S1907: Yes), the information processing device 100 represents the partial route by a solid line arrow (S1908), and proceeds to S1910. When the information processing device 100 determines that the connection area ratio is less than 0.8 (S1907: No), the information processing device 100 represents the partial route by a dotted line arrow (S1909), and proceeds to S1910.

Next, the information processing device 100 determines whether the connection component is a terminal component (S1910). When the information processing device 100 determines that the connection component is a terminal component (S1910: Yes), the information processing device 100 displays “TERM” with the component name of the selected connection component (S1911), and returns to S1904. When the information processing device 100 determines that the connection component is not a terminal component (S1910: No), the information processing device 100 returns to S1904.

When the information processing device 100 determines that there is no not-yet-selected connection component (S1904: No), the information processing device 100 increments j by “1” (S1912), and returns to S1903.

When the information processing device 100 determines that j is not smaller than the number of layers to be displayed (S1903: No), the information processing device 100 ends a series of processing.

As described above, for example, when a ratio between an area of a contact surface that is in contact with a second component from among the surfaces of a first component and an area of a contact portion of the contact surface is less than a reference value, the information processing device 100 determines that there is no connection between the first and second components and excludes a partial route between the components from a thermal path. As a result, even when a contact occurs between two components in a simulation space, a partial route between the two components, between which it is highly probable that there is no connection in practice, may be excluded from the thermal path. Thus, the man-hours of the designer for the thermal path may be reduced, and an accuracy of searching for the thermal path may be improved.

When there is a plurality of contact surfaces, the information processing device 100 calculates, for each of the contact surfaces, a ratio between an area of the contact surface and an area of a portion of the contact surface, which is in contact with a second component. The information processing device 100 determines that the first and second components are in connection with each other when it is determined that one of the area ratios for the contact surfaces is the reference value or more, and determines that the first and second components are not in connection with each other when it is determined that the area ratio for any of the contact surfaces is less than the reference value. As a result, even when there is interference between the first and second components in the simulation space, a partial route between the two components, between which it is highly probable that there is no connection in practice, may be excluded from the thermal path. When there is interference between the first and second components in the simulation space, a plurality of surfaces of the first component is in contact with the second component, so that there are the plurality of contact surfaces.

For each of the plurality of surfaces, a reference value corresponding to the surface is provided, and the information processing device 100 determines whether a ratio that is calculated for each of the contact surfaces is the reference value, which corresponds to the contact surface, or more. As a result, even when the sizes or the shapes of the surfaces of the component are different, the presence or absence of a connection between components may be determined, and an accuracy of searching for the thermal path may be improved.

The surfaces of the first component are the respective surfaces of the minimum cuboid enclosing the first component. The information processing device 100 may accurately determine the presence or absence of a connection between components while treating the components to have simplified shapes, so that a time taken for determination of the presence or absence of a connection between the components may be reduced.

The information processing device 100 may display a thermal path indicated by the generated information. As a result, the user may check the thermal path easily.

The information processing device 100 may display components up to the specified layer count starting from a specified start component, from among the components included in the thermal path indicated by the generated information. As a result, the user may check a desired thermal path easily.

The information processing device 100 may display partial routes between the components included in the thermal path so as to distinguish a partial route having a calculated ratio equal to or more than a predetermined value and a partial route having a calculated ratio less than the predetermined value. As a result, the user may check a degree of a connection between components easily.

The thermal path calculation method according to the embodiment may be implemented by causing a computer such as a personal computer or a workstation to execute a thermal path calculation program that is prepared in advance. The thermal path calculation program is recorded in a computer-readable recording medium such as a magnetic disk, an optical disk, or a universal serial bus (USB) flash memory, read from the recording medium, and executed by the computer. The thermal path calculation program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
extracting contact surfaces from among surfaces of a first component of a plurality of components in a simulation space, the respective contact surfaces being in contact with a second component of the plurality of components, the second component being different from the first component;
calculating a ratio between an area of a first contact surface of the contact surfaces and an area of a portion of the first contact surface, the portion being in contact with the second component;
determining whether the calculated ratio is a predetermined reference value or more;
generating first information upon determining that the calculated ratio is the predetermined reference value or more, the first information indicating a thermal path including a partial route between the first and second components; and
generating second information upon determining that the calculated ratio is less than the predetermined reference value, the second information indicating a thermal path not including the partial route between the first and second components.

2. The non-transitory computer-readable recording medium according to claim 1, the process comprising:
calculating a ratio between an area of the respective contact surfaces and an area of a portion of the respective contact surfaces, the portion being in contact with the second component;
determining whether the ratio calculated for the respective contact surfaces is a predetermined respective reference value or more;
generating the first information upon determining that the ratio calculated for any of the contact surfaces is the predetermined reference value thereof or more; and
generating the second information upon determining that all the calculated ratios are less than the predetermined respective reference values.

3. The non-transitory computer-readable recording medium according to claim 2, wherein
the predetermined respective reference values are a same value.

4. The non-transitory computer-readable recording medium according to claim 1, wherein
the surfaces of the first component are respective surfaces of a minimum cuboid enclosing the first component.

5. The non-transitory computer-readable recording medium according to claim 1, the process further comprising:
displaying a to-be-displayed thermal path indicated by the generated information.

6. The non-transitory computer-readable recording medium according to claim 5, the process comprising:
displaying a part of the to-be-displayed thermal path, the part including components up to a specified layer count starting from a specified start component among components included in the to-be-displayed thermal path.

7. The non-transitory computer-readable recording medium according to claim 5, the process comprising:
determining whether the ratio calculated for respective pairs of successive components included in the to-be-displayed thermal path is a predetermined threshold value or more; and
displaying the to-be-displayed thermal path such that a first partial route between a first pair of successive components and a second partial route between a second pair of successive components are displayed so as to be distinguished, the ratio calculated for the first pair of successive components being the predetermined threshold value or more, the ratio calculated for the second pair of successive components being less than the predetermined threshold value.

8. The non-transitory computer-readable recording medium according to claim 1, wherein
the thermal path indicated by the generated information includes the first component.

9. A method of calculating a thermal path, the method comprising:
extracting, by a computer, contact surfaces from among surfaces of a first component of a plurality of components in a simulation space, the respective contact surfaces being in contact with a second component of the plurality of components, the second component being different from the first component;
calculating a ratio between an area of a first contact surface of the contact surfaces and an area of a portion of the first contact surface, the portion being in contact with the second component;
determining whether the calculated ratio is a predetermined reference value or more;
generating first information upon determining that the calculated ratio is the predetermined reference value or more, the first information indicating a thermal path including a partial route between the first and second components; and
generating second information upon determining that the calculated ratio is less than the predetermined reference value, the second information indicating a thermal path not including the partial route between the first and second components.

10. An information processing device, comprising:
a memory; and
a processor coupled to the memory and the processor configured to
extract contact surfaces from among surfaces of a first component of a plurality of components in a simulation space, the respective contact surfaces being in contact with a second component of the plurality of components, the second component being different from the first component,
calculate a ratio between an area of a first contact surface of the contact surfaces and an area of a portion of the first contact surface, the portion being in contact with the second component,
determine whether the calculated ratio is a predetermined reference value or more,
generate first information upon determining that the calculated ratio is the predetermined reference value or more, the first information indicating a thermal path including a partial route between the first and second components, and
generate second information upon determining that the calculated ratio is less than the predetermined reference value, the second information indicating a thermal path not including the partial route between the first and second components.
